(19) United States
(12) Patent Application Publication
(10) Pub. No.: US 2012/0148969 A1
(43) Pub. Date: Jun. 14, 2012

(54) Continuous process for drying microcapsules

(75) Inventors: Michael Curley Krzoska, Little Chute, WI (US); Paul Raymond Proxmire, Larsen, WI (US)

(73) Assignee: Appleton Papers Inc., Appleton, WI (US)

(21) Appl. No.: 12/078,853

(22) Filed: Apr. 7, 2008

(51) Int. Cl. F26B 3/084; F27B 15/09; F26B 23/02; F27B 15/14

(52) U.S. Cl. 432/17; 34/365; 432/25

(57) ABSTRACT

The invention teaches continuous process for rapidly drying a population of pressure sensitive microcapsules. The process comprises the steps of a) preparing a slurry comprising pressure-sensitive microcapsules dispersed in an aqueous carrier solution and encapsulating a non-solid core material; b) providing a pulse combustor having a means for generating a pulsating flow of hot gases, the pulse combustor having an associated combustion chamber with inlet means for introducing fuel and combustion air to the combustion chamber whereby the combination of the pulse combustor and the combustion chamber generate a pulsating flow of hot gases, the pulse combustor having an outlet means for discharging the pulsating flow of hot gases, and a material feed introduction chamber connected proximate the outlet means of the combustion chamber; c) inputting the slurry of microcapsules into the material feed introduction chamber; d) converting the slurry of microcapsules to dried microcapsules in a drying chamber communicating with the combustion chamber through the outlet means, the drying chamber receiving the microcapsule slurry fed into the material feed introduction chamber and the pulsating flow of hot gases; and, e) collecting in a collection assembly associated with the drying chamber the microcapsules dried in the drying chamber, whereby the collected microcapsules are substantially free of breakage.

### BACKGROUND OF THE INVENTION

1. Field of the Invention

This invention relates to an improved method to dry aqueous slurries of pressure sensitive microcapsules.

2. Description of the Related Art

Lockwood U.S. Pat. No. 4,992,039 teaches a pulse combustor including a rotary valve, a combustion chamber and tail pipes. The process is described useful for removing moisture to recover a solid material suspended in a fluid. The fluid is atomized and the resultant spray subjected to the flow of hot air of a heater or heat and shock wave of a pulse combustor to drive off moisture. The solid particles are carried from the drying chamber by the flow of the drying gas and removed from the gas by use of a cyclone separator. Lockwood describes the process as useful for calcining minerals, vaporizing products for distillation or for other chemical processes. Because of the high heats involved, it is suggested that parts be fabricated out of high temperature ceramics such as silicon nitride, carbide, or alumina oxide.

Patents such as Zinn et al., U.S. Pat. No. 5,015,171 describe a frequency and amplitude tunable pulse combustor. Ozer et al., U.S. Pat. No. 5,252,061 describes another version of a pulse combustor. In pulse combustion, gas is burned by combustion and accelerated to a high velocity directed outward as an exhaust plume similar to a small jet engine or small rocket motor exhaust. A material liquid or slurry desired to be dried is pumped into the exhaust gas stream. With the pulse combustor the exhaust plume is made to have some residence time in a larger chamber which functions as a drying chamber. Dried contents settle to the lower portion of the drying chamber separating from the hot exhaust gas which is vented to an outlet means. The above patents describing various pulse combustors and pulse combustion processes are incorporated herein by reference.

Many processes for microencapsulation are known. These include methods for capsule formation such as described in U.S. Pat. Nos. 2,730,456, 2,800,457; and 2,800,458. Other useful methods for microcapsule manufacture are: U.S. Pat. Nos. 4,001,140; 4,081,376 and 4,089,802 describing a reaction between urea and formaldehyde; U.S. Pat. No. 4,100,103 describing reaction between melamine and formaldehyde; and British Patent No. 2,062,570 describing a process for producing microcapsules having walls produced by polymerization of melamine and formaldehyde in the presence of a styrenesulfonic acid. Microencapsulation is also taught in U.S. Pat. Nos. 2,730,457 and 4,197,346. Processes for forming microcapsules from urea-formaldehyde resin and/or melamine formaldehyde resin are disclosed in U.S. Pat. Nos. 4,001,140, 4,081,376; 4,089,802; 4,100,103; 4,105,823; 4,444,699. Alkyl acrylate—acrylic acid copolymer capsules are taught in U.S. Pat. No. 4,552,811. Each patent described is incorporated herein by reference to the extent each provides guidance regarding microencapsulation processes and materials. More recent microencapsulation techniques involve membrane diffusion such as taught in Seehafer et al., U.S. Pat. No. 6,890,592.

A common aspect of various coacervation, interfacial, and membrane diffusion processes is that the resulting microcapsules are obtained as a slurry in an aqueous carrier. For many applications, and for efficiency in transport, it is often desirable to fashion dry microcapsules.

Various techniques for drying microcapsules are known including spray drying, concurrent atomization, countercurrent atomization, rotary atomization and fluidized bed. Removing the water eliminates the cost and weight associated with transport water if the microcapsules need to be shipped to a different location before use. The problem with current methods of driving off moisture in microencapsulation processes is that either the processes are severely energy intensive or the processes involve high shear at the point of atomization, or involve high pressures. High shear and high pressure are problematic aspects with pressure sensitive microcapsules resulting in undesirable premature breakage of many of the microcapsules. This is particularly a problem for microcapsules having a nonsolid core material since a nonsolid core material does not provide structural support for the capsule during the drying process. Premature breakage of microcapsules in the drying process reduces the commercial quality of the collected microcapsules and the efficiency of the drying process itself as the core contents prematurely released can in some cases interfere with the drying process itself or contaminate the processing equipment.

### BRIEF DESCRIPTION OF THE DRAWINGS

FIG. 1 is a schematic of a pulse combustor with an associated combustion chamber 4 according to the invention, depicting drying chamber 9 communicating with combustion chamber 4 through outlet means 7.

FIG. 2 is a schematic of an alternative pulse combustor design with associated combustion chamber 9 communicating with combustion chamber 4 through outlet means 7.

FIG. 3 is an alternative embodiment of a pulse combustor.

### SUMMARY OF INVENTION

The invention disclosed herein in one embodiment in a continuous process for rapidly drying a population of pressure sensitive microcapsules, the process comprising: a) preparing a slurry material comprising pressure-sensitive microcapsules dispersed in an aqueous carrier solution and encapsulating a non-solid core material; b) providing a pulse combustor having a means for generating a pulsating flow of hot gases, the pulse combustor having an associated combustion chamber with inlet means for introducing fuel and combustion air to the combustion chamber whereby the combination of the pulse combustor and the combustion chamber generating a pulsating flow of hot gases, the pulse combustor having an outlet means for discharging the pulsating flow of hot gases, and a material feed introduction chamber connected proximate the outlet means of the combustion chamber; c) inputting the slurry of microcapsules into the material feed introduction chamber; d) converting the slurry of microcapsules to dried microcapsules in a drying chamber communicating with the combustion chamber through the outlet means, the drying chamber receiving the microcapsule slurry fed into the materials feed introduction chamber and the pulsating flow of hot gases; and e) collecting in a collection assembly associated with the drying chamber the microcapsules dried in the drying chamber, whereby the collected microcapsules are separated substantially free of breakage.

In a further embodiment, preferably the combustion air at the outlet means is at a temperature of at least 77° C.

In a yet further embodiment, preferably air is injected into the pulse combustor at a pressure of at least 30 psi.

In a yet further embodiment, preferably the microcapsule slurry is input into the reactor such that the concentration rate of the solids in the slurry is from 1 to 65% solids.

In a yet further embodiment a separator means is provided for separating the flow of hot gases from the dried microcapsules exiting the drying chamber, whereby the dried microcapsules are separated substantially free of breakage.

### DETAILED DESCRIPTION

The invention teaches a method for drying pressure sensitive microcapsules in large volume. Although the process is energetic, surprisingly it can be adapted to dry pressure sensitive microcapsules without excessive breakage.

The invention teaches a continuous process for rapidly drying a population of microcapsules. The process comprises the steps of preparing a conventional slurry of pressure sensitive microcapsules in a liquid carrier. Typically with coacervation, interfacial and membrane diffusion processes of microencapsulation, microcapsules are formed as a suspension in an aqueous carrier. This suspension or aqueous slurry carries a significant weight or volume of water which can lead to considerable expense in transport.

A useful method of drying the aqueous slurry involves providing a pulse combustor having a means for generating a pulsating flow of hot gases. Typically the pulse combustor has an associated combustion chamber with inlet means such as an inlet pipe for introducing fuel and combustion air to the combustion chamber. The pulse combustor's combustion chamber is fashioned to generate a pulsating flow of hot gases.

Assemblies for effecting a pulsating flow of hot gases are known in the art and adaptable to the process of the invention. The pulse combustor is provided with an outlet means such as a tail pipe or other outlet opening for discharging the pulsating flow of hot gases. A material feed introduction chamber is provided connected proximate the outlet means of the combustion chamber in the path of the outflowing pulsating hot gases.

A slurry of pressure sensitive microcapsules is input or fed into the material feed introduction chamber. The material feed introduction chamber or inlet means can take the form of a pipe, a pipe with sprayer openings, or a pipe fitted with an impeller shaped sprayer. The pipe opening can be simple or more involved such as periodic openings in the pipe, a shaped sprayer, sprayer arms, nozzles, and the like.

The outflowing hot gases from the combustion chamber convert the slurry to dried microcapsules in a drying chamber communicating with the combustion chamber through the outlet means of the combustion chamber.

The pulsating flow of hot gases converts the slurry to dried microcapsules relying on short duration contact so as not to burn or degrade the microcapsules. A collection assembly is associated with the drying chamber to collect the microcapsules dried in the drying chamber. Surprisingly the pressure-sensitive slurry of microcapsules is able to be introduced to the pulsating flow of hot gases emanating from the combustion chamber without the shock wave fracturing most of the capsules. The collected capsules are substantially free of breakage understood for purpose herein to mean that 80% or more are unbroken, preferably 90% or more are unbroken, more preferably 95% or more are unbroken, and most preferably that 98% or more are unbroken and intact.

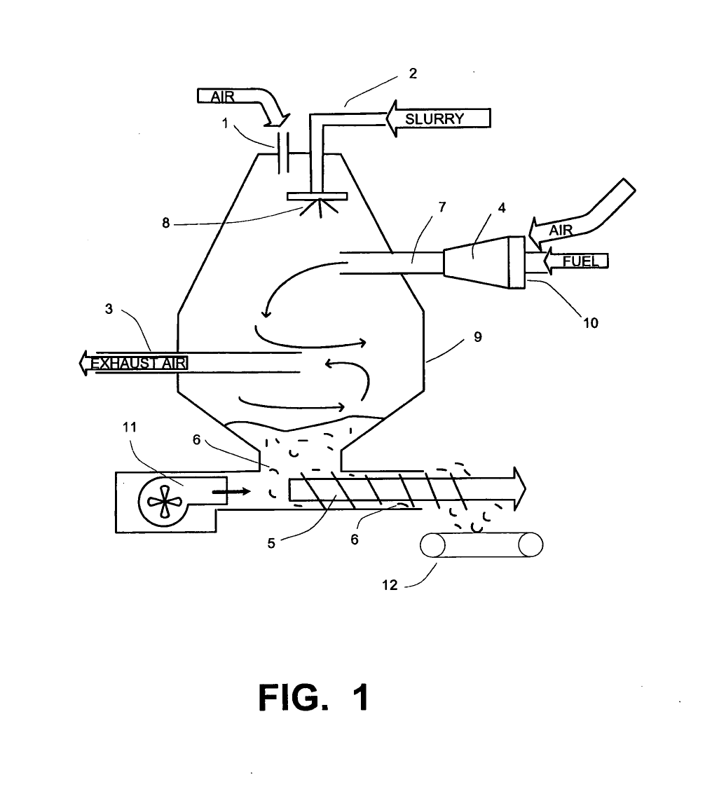

FIG. 1 is a simplified representation of a typical pulse combustor depicting combustion chamber 4 communicating with drying chamber 9 through outlet means 7. Outlet means 7 is essentially a tail pipe of pulse combustor 4 into which air is periodically inserted through air inlet means 10. Fuel is shown fed to pulse combustor 4. Air inlet 1 optionally can feed additional cooling air to drying chamber 9. A microcapsule slurry is fed through material feed introduction chamber 2 shown non-limitatively as a pipe with spray 8. Spray 8 can take the form of simple openings in the pipe.

The hot gases emanating from combustion chamber 4 through outlet means 7 intermix with the microcapsule slurry fed through chamber 2 and spray 8. The slurry is rapidly dried in drying chamber 9. The dried microcapsules 6 settle to the bottom and the hot gases are exhausted through exhaust means 3 shown as an exhaust pipe. Exhaust means 3 can be coupled with a separator means such as a screen, a hood, a separator assembly, venturi, bag assembly, filter, grating, mesh, baffles, and the like.

Optional auger 5 or optionally a conveyor, or simple gravity drop can be used to remove collected dried microcapsules 6. Optionally sonic pulses such as with a transducer can be imparted to dried microcapsules 6 to keep them entrained or fluid-like to facilitate movement through collecting auger 5 or if a conveyor is used. Auger 5 can reciprocate if desired. If an auger is employed it should rotate slowly and be outfitted with pliable fins or vanes to gently move the capsules without rupture. An air stream or suction or gravity drop for collection purposes can optionally and preferably be substituted for auger 5.

Combustion air can be introduced through inlet means 10 or diluent air can be separately introduced to the drying chamber 9 through air inlet 1. The diluent air can serve the purpose of cooling the hot gases emanating from combustion chamber 4.

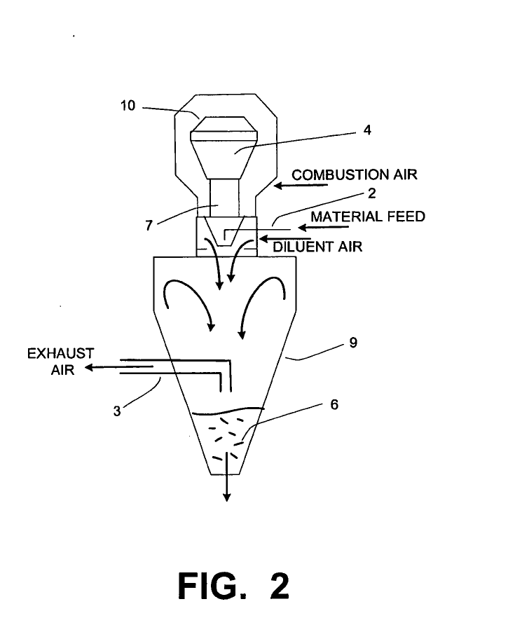

FIG. 2 is an alternative configuration of a pulse combustor 4 and drying chamber 9 useful in the invention. In FIG. 2 combustor 4 is shown in a vertical arrangement with outlet means 7 for discharging the hot gases generated in combustor 4. Material feed introduction chamber 2 is depicted as an elbowed pipe shown proximate the outlet means 7 of the combustor 4.

The microcapsule slurry pumped in through material feed introduction chamber 2 intermixes with the hot gases coming out of outlet means 7. The hot gases and slurry intermix in drying chamber 9. Diluent air can optionally be introduced at the top of the drying chamber 9 as depicted in FIG. 2. In FIG. 2, dried microcapsules are shown collecting and being discharged by gravity and residual air through an outlet in the bottom of drying chamber 9. Exhaust gas separates from the microcapsule slurry exiting through exhaust means 3. Combustion air can be introduced through air inlet means 10.

It was found that surprisingly, pressure sensitive microcapsules have a lower rate of fracture and higher rate of survivability although dried by an energetic pulse combustor. When compared to dried capsules dried by other methods, the capsules dried using pulse combustor methods of the invention had lower permeability values meaning that a higher percentage of the capsules were intact after drying as compared to capsules dried by other methods.

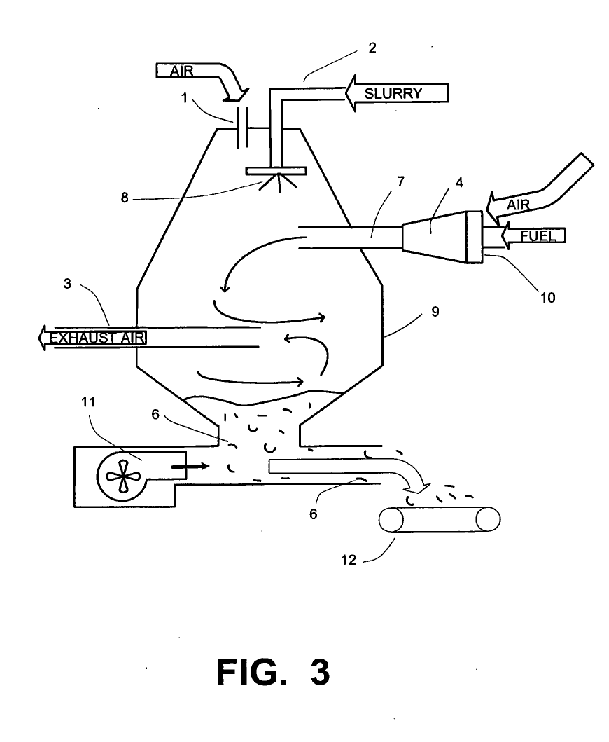

FIG. 3 is an alternative arrangement for a pulse combustor apparatus for drying microcapsule slurry. FIG. 3 shows an optional arrangement of a fan blower 11 or optional conveyor 12 for moving collected dried microcapsules from drying chamber 9.

As will be evident to the skilled artisan, the pulse combustor can be provided with rotary valves such as taught in Lockwood U.S. Pat. No. 4,708,159 incorporated herein by reference, to periodically feed the air needed for pulsed combustion in combustion chamber 4. Other valving such as electronic valves can be substituted for rotary valves. A pulse combustor according to Zinn et al. U.S. Pat. No. 5,015,171 could also be usefully adapted for use in the invention.

The wet microcapsules subjected to heated gas lose moisture until the vapor pressure of the moisture of the drying capsules approaches the partial pressure of the vapor in the gas. The extent of drying is influenced by temperature of the gas and residence as to the extent of the theoretical dryness which can be achieved. Ideally the residence time in the drying chamber is selected sufficient to dry the slurry material yielding a free flowing solid. Preferably the moisture content on the basis of weight is from 0 to 20%, or even 0 to 14%, preferably from 0 to 8%, 0 to 5% or even from 0 to 2% by weight.

It should be understood that the measurement is approximate in that moisture can be physically bound in pores and capillaries, in the internal phase.

The drying aspect primarily is intended to describe surface moisture content such that free flowing dried capsule solids are obtained.

### EXAMPLES

### Example 1

### Melamine Capsule

25 grams of butyl acrylate-acrylic acid copolymer emulsifier (Colloid C351, 25% solid, pka 4.5-4.7, (Kemira Chemicals, Inc. Kennesaw, Ga.)) is dissolved and mixed in 200 grams deionized water. The pH of the solution is adjusted to pH of 4.0 with sodium hydroxide solution. 8 grams of partially methylated methylol melamine resin (Cymel 385, 80% solid, (Cytec Industries West Paterson, N.J.)) is added to the emulsifier solution. 200 grams of internal phase oil and optional additional core is added to the mixture under mechanical agitation and the temperature is raised to 40 to 70° C. After mixing at higher speed until a stable emulsion is obtained, 4 grams of sodium sulfate salt are added to the emulsion. 10 grams of butyl acrylate-acrylic acid copolymer emulsifier (Colloid C351, 25% solid, pka 4.5-4.7, Kemira), 120 grams of distilled water, sodium hydroxide solution to adjust pH to 4.8, 25 grams of partially methylated methylol melamine resin (Cymel 385, 80% solid, Cytec) is added. This mixture is heated to 65 to 70° C. and maintained overnight with continuous stirring to complete the encapsulation process. An average capsule size of 30 um is obtained as analyzed by a Model 780 Accusizer.

### Example 2

### Melamine Formaldehyde (MF) Capsule

23.75 grams of polyacrylic acid emulsifier (Noveon Inc., Cleveland, Ohio)) is dissolved and mixed in 815 grams deionized water. The pH of the solution is adjusted to pH of 5.60 with sodium hydroxide solution and the temperature is adjusted to 50 to 60° C. 70 grams of partially methylated methylol melamine resin (Cymel 385, 80% solid, (Cytec Industries West Paterson, N.J.)) is added to the emulsifier solution. 1250 grams of internal phase oil and optional additional core is added to the mixture under mechanical agitation followed by 25.0 grams of polyacrylic acid emulsifier 25% solids, 500 grams deionized water, and 70 grams of partially methylated methylol melamine resin (Cymel 385, 80% solid, (Cytec Industries West Paterson, N.J.)) adjusted to pH 5.0. 15 grams of sodium sulfate salt are then added to the emulsion. This mixture is heated to 65 to 70° C. until completion of the encapsulation process. An average capsule size of 20 um is obtained as analyzed by a Model 780 Accusizer (Particle Sizing Systems, Santa Barbara, Calif.).

### Example 3

### Production of Rotary Atomization Dried Microcapsule

1200 g of microcapsule slurry encapsulating a volatile oil core material, containing one or more of the variants of microcapsules described in the above examples is mixed together with 700 g of water for 10 minutes using an IKA Eurostar mixer with R1382 attachment at a speed of 180 rpm. The mixture is then transferred over to a feeding vessel to be spray dried in a 1.2 m diameter Niro Production Minor. The slurry is fed into a tower using a Watson-Marlow 504U peristaltic pump and atomized using a 100 mm diameter rotary atomizer run at 18000 rpm, with co-current air flow for drying. The slurry is dried using an inlet temperature of 200° C. and outlet temperature of 95° C. to form a fine powder. The equipment used for the spray drying process may be obtained from the following suppliers: IKA Werke GmbH & Co. KG, Janke and Kunkel—Str. 10, D79219 Staufen, Germany; Niro A/S Gladsaxevej 305, P.O. Box 45, 2860 Soeborg, Denmark and Watson-Marlow Bredel Pumps Limited, Falmouth, Cornwall, TR11 4RU, England.

### Example 4

### Urea Formaldehyde Capsule

Into a mixture of 89.5 grams of water, 5 grams of urea, 0.5 gram of resorcinol and 5 grams of an alkyl acrylate-acrylic acid copolymer, adjusted to pH 4.0, are emulsified 90 grams of oil and optional additional core material. These mixtures are emulsified and the resulting mixture placed in a container which is mounted in a room temperature water bath. Continuous stirring is provided, 13.5 grams of 37% formaldehyde solution are added and the bath heated to 55° C. and maintained at that temperature overnight to initiate and complete encapsulation.

### Example 5

### Example Illustrating Process of Forming Microcapsules

Into 153 grams of a mixture of 149.5 grams of water and 3.5 grams of the acrylic acid-alkyl acrylate copolymer, adjusted to pH 5.0, emulsify 180 grams of the intended capsule core material solution. A second mixture of 6.5 grams of acrylic acid-alkyl acrylate copolymer and 65 grams of water is prepared and adjusted to pH 5.0 and 20 grams of a partially methylated methylol melamine resin solution (“Resimene 714,” 80 percent solids, Monsanto Company, St. Louis, Mo.) is added and this mixture in turn added with stirring to the above-described emulsion. Continuous stirring is provided and the bath is heated to 55° C. and maintained at this temperature, with continuous stirring, overnight to initiate and complete encapsulation.

Various other processes for microencapsulation, and exemplary methods and materials are set forth in Schwantes (U.S. Pat. No. 6,592,990), Nagai et al. (U.S. Pat. No. 4,708,924), Baker et al. (U.S. Pat. No. 4,166,152), Wojciak (U.S. Pat. No. 4,093,556), Matsukawa et al. (U.S. Pat. No. 3,965,033), Matsukawa (U.S. Pat. No. 3,660,304), Ozono (U.S. Pat. No. 4,588,639), Irgarashi et al. (U.S. Pat. No. 4,510,927), Brown et al., (U.S. Pat. No. 4,552,811), Scher (U.S. Pat. No. 4,285,720), Shioi et al., (U.S. Pat. No. 4,601,863), Kiritani et al., (U.S. Pat. No. 3,886,085), Jahns et al. (U.S. Pat. Nos. 5,596,051 and 5,292,835), Matson (U.S. Pat. No. 3,516,941), Chao (U.S. Pat. No. 6,375,872), Foris et al., (U.S. Pat. Nos. 4,001,140; 4,087,376; 4,089,802 and 4,100,103), Greene et al. (U.S. Pat. Nos. 2,800,458; 2,800,457 and 2,730,456), Clark (U.S. Pat. No. 6,531,156), Saeki et al. (U.S. Pat. Nos. 4,251,386 and 4,356,109), Hoshi et al. (U.S. Pat. No. 4,221,710, Hayford (U.S. Pat. No. 4,444,699), Hasler et al. (U.S. Pat. No. 5,105,823), Stevens (U.S. Pat. No. 4,197,346), Riecke (U.S. Pat. No. 4,622,267), Greiner et al. (U.S. Pat. No. 4,547,429), and Tice et al. (U.S. Pat. No. 5,407,609), among others and as taught by Herbig in the chapter entitled “Encapsulation” in Kirk Othmer, Encyclopedia of Chemical Technology, V.13, Second Edition, pages 436-456 and by Huber et al. in “Capsular Adhesives,” TAPPI, Vol. 49, No. 5, pages 41A-44A, May 1966, all of which are incorporated herein by reference.

Microcapsules are useful with a wide variety of capsule contents (“core materials”) including, by way of illustration and without limitation, dyes, perfumes, fragrances, cleaning oils, polishing oils, flavorants, sweeteners, chromogens, pharmaceuticals, fertilizers, herbicides, scents, and the like. The microcapsule core materials can include materials which alter rheology or flow characteristics, or extend shelf life or product stability. Essential oils as core materials can include, for example, by way of illustration wintergreen oil, cinnamon oil, clove oil, lemon oil, lime oil, orange oil, peppermint oil and the like. Dyes can include fluorans, lactones, indolyl red, I6B, leuco dyes, all by way of illustration and not limitation. The core material should be dispersible or sufficiently soluble in the capsule internal phase material namely in the internal phase oil or soluble or dispersible in the monomers or oligomers solubilized or dispersed in the internal phase oil When the internal phase is water, the core material should be dispersible or sufficiently soluble in the water phase. The invention is particularly useful to encapsulate volatile fragrances and flavorants. When a water phase is being microencapsulated, with the oil phase serving as the continuous phase, the core material should be soluble or dispersible in the water phase so as to form a dispersion in water that can be emulsified into the oil phase.

### Example 6

### Melamine Alkylacrylate Microcapsule and Permeability

| | Median Vol. Wgt. Capsule | |
|---|---|---|
| Batch ID | Size | Initial Slurry Permeability |
| A | 13.71 microns | 9.3 ± 0.9 |
| B | 15.99 microns | 9.6 ± 1.7 |
| A/B | 15.03 microns | 10.9 ± 2.3 |

Pulse Combustion Dried Capsules

| | | Δ (Permeability before drying |
|---|---|---|
| | | subtracted from permeability after |
| | Permeability (dried) | drying) |
| Run B | 12.3 ± 2.5 | 1.4 ± 3.4 |
| Run C | 8.8 ± 1.0 | −2.1 ± 2.5 |
| Run D | 9.0 ± 0.7 | −1.9 ± 2.4 |
| Run E | 10.4 ± 1.3 | −0.5 ± 2.6 |
| Run F | 12.5 ± 2.6 | 1.6 ± 3.5 |
| Run G | 13.7 ± 3.6 | 2.8 ± 4.3 |

Rotary Atomization Dried Capsules

| | | Δ (Permeability before drying |
|---|---|---|
| | | subtracted from permeability |
| | Permeability (dried) | after drying) |
| 25% Slurry Solids | 35.0 ± 1.2 | 24.1 ± 2.6 |
| 50% Slurry Solids | 22.6 ± 1.6 | 11.7 ± 2.8 |

Concurrent Atomization Dried Capsules

| | | Δ (Permeability |
|---|---|---|
| | | before drying |
| | | subtracted from |
| | Permeability (dried) | permeability after drying) |
| 10 psi Nozzle | 26.4 ± 3.7 | 15.5 ± 4.4 |
| Pressure Collected | | |
| Sample | | |
| 5 psi Nozzle | 24.2 ± 1.2 | 13.3 ± 2.6 |
| Pressure Knockdown | | |
| 20 psi Nozzle | 19.9 ± 2.5 | 9.0 ± 3.4 |
| Pressure Collected | | |
| Sample | | |
| 10 psi Nozzle | 33.6 ± 2.4 | 22.7 ± 3.3 |
| Pressure Knockdown | | |

The microcapsules were prepared in the standard manner, split into two partitions and diluted to ˜25% with deionized water. These capsules were then dried using 3 different drier configurations: Co-current high pressure nozzle atomization, Rotary atomization, and Pulse combustion atomization.

For all drying configurations, the microcapsule slurry was placed in a reservoir and constantly agitated using low shear mixing to keep the capsules dispersed in the slurry. The slurries were pumped via a peristaltic pump into the atomizer at varying flow rates to maintain a constant drier outlet temperature of 90° C. to 121° C. Inlet temperatures for the co-current and the rotary atomization were between 160° C. and 210° C. The contact temperatures for the pulse combustor were between 537° C. and 650° C. Important variables for the pulse combustor are the exit temperature, the turbo air, the exhaust air and the percent solids of the slurry (ideally less than 50% solids). Higher percent solids can be used; however, there is a negative effect on the quality of the dried product. The damage to the capsules is measured by a permeability test, where the capsules are suspended in a solvent that will solubilize the material in the capsules, but will not damage the capsule wall itself. This step will solubilize any material outside the capsule wall and any material within a damaged capsule. The sample is then treated with a solvent to break down the capsule wall and solubilize the core material, to extract the core material in the undamaged capsules. These extractions are then analyzed by gas chromatography. The permeability is a percentage equal to the first extraction divided by the sum of the first and second extractions. A lower permeability number indicates less capsule damage.

### Co-Current High Pressure Nozzle Atomization:

This drying technique produced less damage to the capsules than the rotary atomization, but significantly more damage than the pulse combustion drying (95% CI). At 5% psi, the slurry did not atomize well and there was not enough sample collected after the cyclone for testing as almost all of the material remained in the drying chamber. Higher pressures produced enough sample to for testing, but the optimum of 20 psi (as determined from previous experiments. Pressures as high as 80 psi have been evaluated, resulting in considerable damage to the microcapsules) still resulted in higher difference in permeability than the best pulse dried material.

Cocurrent Atomization Dried Capsules

| | | | 20 psi |
|---|---|---|---|
| | | | Nozzle |
| | 5 psi | 10 psi | Pressure |
| | Nozzle Pressure | Nozzle Pressure | Collected |
| Run ID | Collected Sample | Collected Sample | Sample |
| Permeability | Not Enough Sample | 26.4 ± 3.7 | 19.9 ± 2.5 |
| ΔP (Permeability | NA | 15.5 ± 4.4 | 9.0 ± 3.4 |
| before drying | | | |
| subtracted from | | | |
| permeability after | | | |
| drying) | | | |

### Rotary Atomization:

This drying technique resulted in the greatest damage to the microcapsules. There was considerable buildup on the inside of the drying chamber after several minutes of running. Very little sample was collected in the collection can using the optimum conditions. Higher rotor speeds resulted in more capsules on the walls of the drying chamber and lower rotor speeds resulted in large agglomerates that remained in the bottom of the drying chamber and in the outlet of the drying chamber.

Rotary Atomization Dried Capsules

| Run ID | Collected Sample |
|---|---|
| Permeability | 35.0 ± 1.2 |
| ΔP (Permeability | 24.1 ± 2.6 |
| before drying | |
| subtracted from | |
| permeability after | |
| drying) | |

### Pulse Combustion Atomization:

This drying technique produced the least amount of damage to the capsules and the largest quantity of useable capsule product. This method resulted in significantly less damage to the microcapsules than the other methods tested. As seen from the chart below, all of the runs using the pulse combustion method were significantly lower (at 95% confidence) in ΔP when compared to the rotary atomization and several of the runs at the optimum 20 psi in the co-current atomization were significantly lower (runs C, D, J, K, and L). Besides the reduced damage to the capsules during the drying process, the pulse drying system also has the additional benefit of being much more difficult to plug the feed injection.

Pulse Combustion Dried Capsules

| Run ID | Run B | Run C | Run D | Run E | Run F | Run G |
|---|---|---|---|---|---|---|
| Permeability | 12.3 ± 2.5 | 8.8 ± 1.0 | 9.0 ± 0.7 | 10.4 ± 1.3 | 12.5 ± 2.6 | 13.7 ± 3.6 |
| ΔP (Permeability | 1.4 ± 3.4 | −2.1 ± 2.5 | −1.9 ± 2.4 | −0.5 ± 2.6 | 1.6 ± 3.5 | 2.8 ± 4.3 |
| before drying | | | | | | |
| subtracted from | | | | | | |
| permeability after | | | | | | |
| drying) | | | | | | |
| | Rotary Drying Comparison (95% Confidence Interval) | | | | | |
| | Difference is | Difference is | Difference is | Difference is | Difference is | Difference is |
| | Significant | Significant | Significant | Significant | Significant | Significant |
| | Cocurrent Drying Comparison @ 20 psi (95% Confidence Interval) | | | | | |
| | Difference is | Difference is | Difference is | Difference is | Difference is | Difference is |
| | Not Significant | Significant | Significant | Significant | Not Significant | Not Significant |

| Run ID | Run H | Run J | Run K | Run L | Run M |
|---|---|---|---|---|---|
| Permeability | 18.9 ± 4.5 | 12.5 ± 0.8 | 12.2 ± 1.6 | 11.5 ± 0.7 | 20.1 ± 3.6 |
| ΔP (Permeability | 8.0 ± 5.1 | 1.6 ± 2.4 | 1.3 ± 2.8 | 0.6 ± 2.4 | 9.2 ± 4.3 |
| before drying | | | | | |
| subtracted from | | | | | |
| permeability after | | | | | |
| drying) | | | | | |
| | Rotary Drying Comparison (95% Confidence Interval) | | | | |
| | Difference is | Difference is | Difference is | Difference is | Difference is |
| | Significant | Significant | Significant | Significant | Significant |
| | Cocurrent Drying Comparison @ 20 psi (95% Confidence Interval) | | | | |
| | Difference is | Difference is | Difference is | Difference is | Difference is |
| | Not Significant | Significant | Significant | Significant | Not Significant |

### Pulse Drier Operating Conditions:

### Pulse Drier (100,000 BTU/Hr Drier)

### Solids:

Minimum: 1% solids

Maximum: 65% Solids

Preferably: 20 to 35% solids

### Exit Temperature:

Minimum: 175° F. (77° C.)

Maximum: 300° F. (148° C.)

Preferably: 200° F. (93° C.) to 250° F. (121° C.)

### Turbo Air:

Minimum: 30 psi

Maximum: 90 psi

Preferably: 50 to 75 psi

### Exhaust Air:

Minimum: 45%

Maximum: 90%

Preferably: 45% to 70%

### Example 7

Microcapsule slurries were dried using three different types of atomization (concurrent atomization, rotary atomization and pulse combustion) and the permeability (ratio of unencapsulated core material to total core material) was measured before and after drying. Microcapsules dried using the process of the invention had significantly reduced damage to the microcapsules while drying. The process of the invention yielded microcapsules substantially free of breakage.

Capsule Permeability after drying with the following methods:

| Initial Capsule | | Concurrent | |
|---|---|---|---|
| Permeability | Rotary Atomization | Atomization | Pulse Combustion |
| 17.4 | N/A | 36.9 | 19.5 |
| 11.2 | 68.7 | 48.0 | N/A |

What is claimed is:

1. A continuous process for rapidly drying a population of pressure sensitive microcapsules, said process comprising:
a) preparing a slurry material comprising pressure-sensitive microcapsules dispersed in an aqueous carrier solution and encapsulating a non-solid core material;
b) providing a pulse combustor having a means for generating a pulsating flow of hot gases, the pulse combustor having an associated combustion chamber with inlet means for introducing fuel and combustion air to the combustion chamber whereby the combination of the pulse combustor and the combustion chamber generate a pulsating flow of hot gases, the pulse combustor having an outlet means for discharging the pulsating flow of hot gases, and a material feed introduction chamber connected proximate the outlet means of the combustion chamber;
c) inputting the slurry of microcapsules into the material feed introduction chamber;
d) converting the slurry of microcapsules to dried microcapsules in a drying chamber communicating with the combustion chamber through the outlet means, the drying chamber receiving the microcapsule slurry fed into the material feed introduction chamber and the pulsating flow of hot gases;
e) collecting in a collection assembly associated with the drying chamber the microcapsules dried in the drying chamber, whereby the collected microcapsules are separated substantially free of breakage.

2. The process according to claim 1 wherein the process wherein the combustion air at the outlet means is at a temperature of at least 77° C.

3. The process according to claim 1 wherein the air is injected into the pulse combustor at a pressure of at least 30 psi.

4. The process according to claim 1 wherein, the microcapsule slurry is input into the reactor at a slurry concentration of from 1 to 65% solids.

5. The process according to claim 1 wherein the residence time of the slurry in the drying chamber is selected sufficient to dry the slurry material.

6. The process according to claim 1 wherein the microcapsules are dried to a moisture content of from 0 to 14%.

7. A continuous process for rapidly drying a population of pressure sensitive microcapsules, said process comprising:
a) preparing a slurry material comprising pressure-sensitive microcapsules dispersed in an aqueous carrier solution and encapsulating a non-solid core material;
b) providing a pulse combustor having a means for generating a pulsating flow of hot gases, the pulse combustor having an associated combustion chamber with inlet means for introducing fuel and combustion air to the combustion chamber whereby the combination of the pulse combustor and the combustion chamber generate a pulsating flow of hot gases, the pulse combustor having an outlet means for discharging the pulsating flow of hot gases, and a material feed introduction chamber connected proximate the outlet means of the combustion chamber;
c) inputting the slurry of microcapsules into the material feed introduction chamber;
d) converting the slurry of microcapsules to dried microcapsules in a drying chamber communicating with the combustion chamber through the outlet means, the drying chamber receiving the microcapsule slurry fed into the material feed introduction chamber and the pulsating flow of hot gases;
e) collecting in a collection assembly associated with the drying chamber the microcapsules dried in the drying chamber;
f) separating the dried microcapsules with separator means provided for separating the flow of hot gases from the dried microcapsules exiting the drying chamber, whereby the dried microcapsules are separated substantially free of breakage.

8. The process according to claim 7 wherein the combustion air at the outlet means is at a temperature of at least 77° C.

9. The process according to claim 7 wherein the microcapsule slurry is input into the reactor at a rate of from 1 to 65% solids.

10. The process according to claim 7 wherein the residence time of the slurry in the drying chamber is sufficient to dry the slurry material such that the exit temperature of the gases at the outlet means is from 60° C. to 130° C.

11. The process according to claim 7 wherein the microcapsules are dried to a moisture content of from 0 to 8%.
